(19) United States
(12) Patent Application Publication
(10) Pub. No.: US 2003/0099532 A1
(43) Pub. Date: May 29, 2003

(54) Vehicle body with integral storage area and deck

(76) Inventor: Timothy R. Williams, Charlotte, MI (US)

Correspondence Address: FOSTER, SWIFT, COLLINS & SMITH, P.C., 313 SOUTH WASHINGTON SQUARE, LANSING, MI, 48933, US

(21) Appl. No.: 10/003,589

(22) Filed: Nov. 26, 2001

(51) Int. Cl. B65G 67/02

(52) U.S. Cl. 414/538; 414/537; 414/559

(57) ABSTRACT

This invention is an improved vehicle body that allows development of a large storage compartment having a chassis mounted deck to assist in loading and unloading an auxiliary load to ground level in less space while maintaining proper vehicle ground clearance. The invention can have body walls in combination with a drop deck and a ceiling to define the storage compartment, at least one hatch hingedly attached to the body having means to raise, lower, and retain the drop deck in a closed position. The invention can add gas shocks on the hatch and line the storage compartment with reinforcements such as firewall rated materials. A winch device, cable and dolly can be added to assist in loading or unloading the auxiliary load. A means to prevent the vehicle from driving off when the drop deck is in a lowered position can also be included.

### CROSS REFERENCE TO RELATED APPLICATIONS

This application claims priority to a non-provisional patent application Ser. No. 09/722,909 titled “Improved Heavy Vehicle Chassis with Rear Drop Deck,” filed Nov. 27, 2000. The entire disclosure of Ser. No. 09/722,909 is incorporated herein by reference in its entirety.

### BACKGROUND OF THE INVENTION

1. Field of the Invention

The present invention relates to an improved vehicle body configuration and, more particularly, to a recreational vehicle with a deck and large integral storage space.

2. Background and Description of the Prior Art

In many large vehicles, a chassis frame houses the vehicle's mechanical workings such as the suspension, engine, powertrain, and braking systems. A typical recreational vehicle has a chassis, a superstructure, and a body. See Generally, U.S. Pat. No. 5,863,070 to Williams, et al., and U.S. Pat. No. 5,314,205 to Glesmann. Chassis configuration frequently limits vehicle body design.

Large recreational vehicles, not surprisingly, require large engines to propel them. A variety of engine placement configurations within the chassis are possible. Rear engine configurations (where the engine is mounted behind a rear axle) are common in large recreational vehicle chassis designs and are often referred to as “pushers.” This popular chassis configuration results in a large engine housing that usually occupies most of the rear of the chassis and even extends upwards into the rear body of the recreational vehicle.

Engine placement forward of the front axle or engine placement between the front and rear axle (mid-engine) is desirable and eliminates space restrictions in the rearward portion of the chassis. A large vehicle mid-engine chassis configuration is the subject of U.S. patent application Ser. No. 09/722,909 to Williams. Each engine placement configuration allows distinct design flexibility and conveniences. In a mid-engine configuration that is essentially contained within the chassis, there exists an opportunity to find new uses for the area previously used for the rear engine housing.

For example, a conventional recreational vehicle can only tow one vehicle such as a sport utility vehicle. Towing this vehicle restricts options to bring an additional recreational vehicle such as a personal watercraft, golf cart, dirt bike, and the like. Likewise, towed recreational vehicles also would pose similar restrictions. In a forward or mid-engine chassis configuration or in a towed vehicle, an integral storage area to enclose an auxiliary load could be developed in the rear of the chassis or vehicle. Many design configurations and features utilizing this space are possible.

Attempts to develop storage areas in recreational vehicles are known in the art. For example, U.S. Pat. No. 3,961,716 to Renaud describes a mobile housing unit with an integral garage. This garage requires the addition of a separate axle to accept the increased load and the garage actually remains below the vehicle chassis. Although the garage is claimed to be integral, it is essentially a modified and complicated towing arrangement.

Other rear storage compartments are also known in the art. See, U.S. Pat. No. 4,854,631 to Laursen; U.S. Pat. No. 5,314,200 to Phillips; and U.S. Pat. No. 6,135,532 to Martin. The storage configurations in Phillips and Martin require the use of the entire height to the rearward portion of the vehicle body. In all cases, the vehicle side panels are hinged down to provide a steep, heavy, and awkward loading ramp. The high risk of damage to the side panels in these configurations would be unacceptable to many larger recreational vehicles costing several hundred thousand dollars.

Thus, there is a desire and need for an improved vehicle body to take advantage of the design flexibility associated with chassis configurations allowing large and integral storage compartments.

### SUMMARY OF THE INVENTION

Accordingly, the present invention provides an improved vehicle body that provides design flexibility and avoids the deficiencies currently found in the art. The present invention allows development of a large storage space having a chassis mounted drop deck to assist in loading and unloading an auxiliary load, such as a small vehicle, to or from ground level.

The invention is a combination vehicle having an improved integral enclosed storage area that can have adjoining additional interior areas such as living quarters that can extend over the storage area. The present invention does not significantly lower vehicle ground clearance and is economical to produce. The present invention does not need a steep ramp to load vehicles. In one embodiment, these features can combine with a large vehicle chassis to allow the storage of heavy items.

Specifically, the invention is a vehicle having a storage compartment to enclose an auxiliary load having a chassis with a drop deck, a body mounted to the chassis comprising body walls in combination with the drop deck and a ceiling to define the storage compartment. The invention would also have at least one hatch hingedly attached to the body. The drop deck has a means to raise it to a closed position, lower it to an open position, and secure the drop deck in the closed position.

The storage compartment can be lined with a firewall rated material. Gas shocks attached to the hatch edge and vehicle body can assist in raising the hatch and holding it an open position. The drop deck can be hingedly mounted to the chassis and hydraulic lift cylinders can be used to raise and lower the drop deck. In one embodiment of the present invention, at least four hydraulic lift cylinders are configured to lower, raise and store the drop deck in a level plane.

Other features of the present invention can include a means to secure the drop deck in the closed position, including but not limited to a post on the drop deck adjacent and corresponding to a releasable latching device. The latching device in turn can be attached to the chassis and configured to receive the post. A winch device and cable attached to the storage compartment on an interior surface adjacent to the hatch can assist in loading or unloading the auxiliary load. One embodiment can include a wheeled dolly as part of the winch configuration so the vehicles, such as personal watercrafts, can be launched from the storage area. The body walls can be reinforced, whereby injury to the vehicle or surrounding vehicles is minimized if the auxiliary load shifts during transport.

In vehicles with additional interior spaces, the storage compartment can be located in the rear or front of the vehicle, and the hatch correspondingly can be located on a rear wall or front wall of the vehicle. Access doors between the storage compartment and additional interior spaces are possible.

The present invention can also include a means to prevent the vehicle from driving off when the drop deck is in a lowered position. This can be through an indicator lamp, a “kill” switch to prohibit a vehicle operator from lowering the deck if a PRNDL gear selector is not in “Park,” or, if the drop deck is lowered, the alerting of the operator to take the PRNDL gear selector out of “Park.”

Other features of the present invention will become more apparent to persons having ordinary skill in the art to which the present invention pertains from the following description taken in conjunction with the accompanying figures.

### BRIEF DESCRIPTION OF THE FIGURES

The foregoing objects, advantages, and features, as well as other objects and advantages, will become apparent with reference to the description and drawings below, in which like numerals represent like elements and in which:

FIG. 1 illustrates a perspective view of one embodiment of the present invention showing a hingedly mounted drop deck in a lowered position.

FIG. 2 illustrates a side view of one embodiment of the present invention showing the drop deck in a lowered position.

FIG. 3 illustrates a side view of one embodiment of the present invention showing the drop deck in a raised position.

FIG. 4 illustrates a perspective view of an embodiment of the present invention including devices to assist in the loading and unloading of vehicles stored within the integral storage area.

FIG. 5 illustrates an alternate embodiment of the present invention with the drop deck in a level lowered position.

### DETAILED DESCRIPTION OF THE INVENTION

The present invention generally relates to an improved vehicle design having a deck allowing access to a large enclosed storage space integral with other interior vehicle areas such as living quarters. The invention relates to recreational vehicles that either are towed or have chassis configurations that allow the addition of a large storage compartment without the disadvantages of the prior art. The design can be easily and economically integrated into a variety of existing chassis configurations. The storage and living areas can be separated by a firewall known in the art, and access between the two areas is possible. The invention allows the use of none-load bearing side panels.

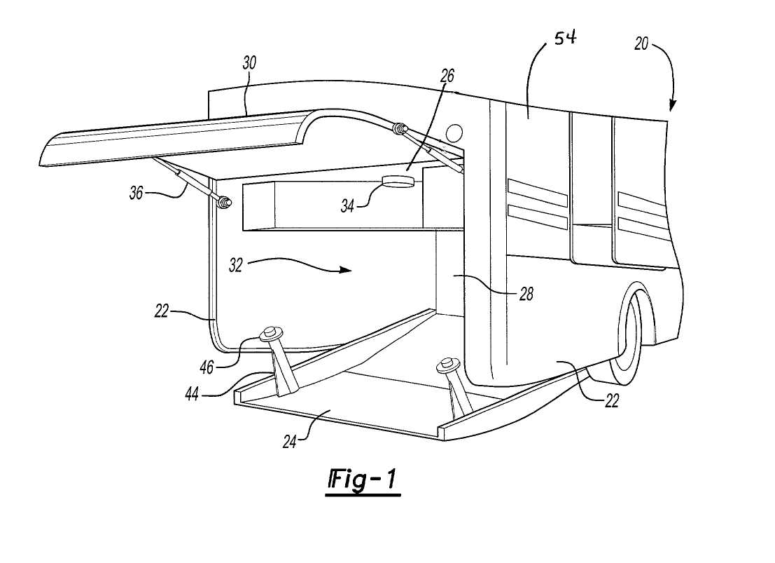

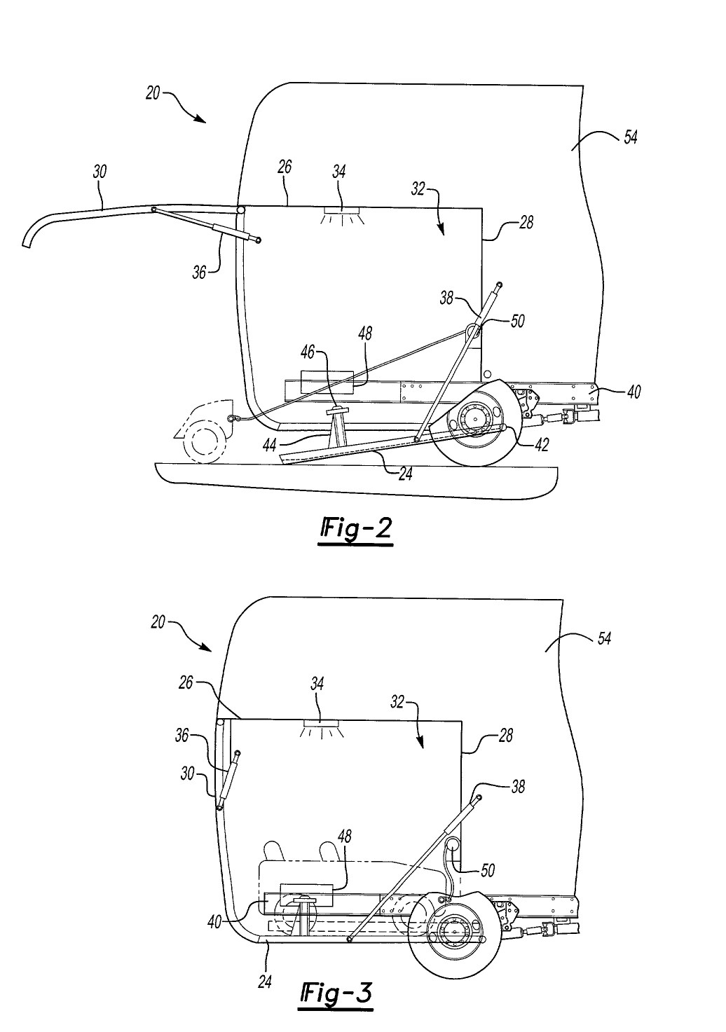

FIG. 1 illustrates a perspective view, and not by way of limitation, of one embodiment of the present invention on a vehicle generally indicated as 20. FIGS. 2 and 3 illustrate side views. The vehicle 20 has a body 54 mounted to a chassis 40 comprising a drop deck 24. The body 54 has body walls such as a pair of side walls 22 and an interior wall 28. The body walls, in combination with the drop deck 24, a ceiling 26, and a hatch 30, generally define a storage compartment 32 to enclose an auxiliary load. The hatch 30 can be hingedly attached and be part of a body wall or the entire body wall. As illustrated, the hatch 30 is a rear wall configuration. In the rear wall configuration, the storage compartment 32 is located in the rear of the vehicle 20 and the hatch 30 is located on the rear wall of the vehicle 20. Other configurations to practice the present invention (not shown) could include placing the storage compartment 32 in the front of the vehicle 20 and placing the hatch 30 on a front wall. Also, the ceiling 26 could extend to the roof of the vehicle 20 or to the hatch 30 located on either side or both sides (adjacent) of the vehicle 20. Two hatches 30 can be located in adjacent body walls.

Many features can be added to add to the utility of the present invention. Interior surfaces of the storage compartment 32 (side walls 22, drop deck 24, ceiling 26, interior wall 28 and hatch 30) can be lined with materials to create a rated firewall or reinforced to allow points to secure an auxiliary load (contents) of the storage compartment 32 during transport. The reinforcement can also contain the auxiliary load if it shifts or breaks loose from its securing means. This can minimize damage or injury to the vehicle as well as surrounding vehicles. An access door (not shown) to other interior spaces of the vehicle 20 can be added to the interior wall 28 or ceiling 26 to allow accessibility to the interior spaces of the vehicle 20. Lights 34 can be added within the storage compartment 32 and can be switchable using a variety of means known in the art. The hatch 30 can be raised with the assistance of at least one gas shock 36 known in the art. The gas shock 36 can have one gas shock 36 end attached to a hatch 30 edge and a second gas shock end attached to the vehicle body 54, thereby assisting in raising the hatch 30 and holding the hatch 30 in an open position as illustrated in the figures. Motorized or other types of mechanical mechanisms could also be added (not shown) to assist in raising the hatch 30 or holding the hatch 30 in an open position.

Many of the improvements of the present invention over the prior art involve the possible deck configurations. In a simple embodiment of the present invention, the deck can merely be fixedly attached to the chassis. Drop deck 24 configurations are also possible and probably more desirable given the flexibility of loading auxiliary loads. The drop deck 24 can have means to raise the drop deck 24 to a closed position, to lower the drop deck 24 to an open position and to secure the drop deck 24 in a closed position. In FIGS. 1 through 3, one edge of the drop deck 24 can be hingedly mounted to the chassis 40 by at least one hinge 42. The embodiment illustrated uses at least one hydraulic lift cylinder 38 having a first cylinder end attached to the chassis 40 and a second cylinder end attached to the edges of the drop deck 24 to provide the sufficient power to raise and lower the drop deck 24 and auxiliary load. The number, placement and size of the hydraulic lift cylinders 38 are based on the particular application, including anticipated size and weight of the auxiliary load as well as chassis 40 configuration. FIG. 2 illustrates a side view of the vehicle 20 showing the drop deck 24 in a lowered position. FIG. 3 illustrates a side view of the illustrated vehicle 20 showing the drop deck 24 in a raised position.

In the lowered position, the drop deck 24 allows easy deployment of the auxiliary loads such as motorcycles, snowmobiles, personal watercraft and other types of vehicles in a small space while having none of the disadvantages of the prior art. Loading and unloading of the auxiliary load can be assisted with an optional winch device and cable 50 attached to the storage compartment 32 on an interior surface adjacent to the hatch 30. The cable of the winch device and cable 50 can be made of any material capable of hauling a desired load.

In the raised position, the drop deck 24 allows sufficient clearance for normal road conditions when adjacent to the chassis 40. The vehicle 20 can have the means to secure the drop deck 24 to an underside of the chassis 40. The drop deck 24 can have at least one post 44 attached to each of the drop deck 24 edges and each of the drop deck 24 edges having a post stop 46. The post stop 46 can be configured to be adjacent and corresponding to a releasable latching device 48 attached to the chassis 40 or the body 54 configured to receive the post stop 46. The latching devices 48 are configured to support the drop deck 24 and the auxiliary load. Several means to latch and unlatch the post stops 46 are possible and are well known in the art. The latching device 48 can be electrically or mechanically activated to release the post stops 46 to allow lowering of the drop deck 24.

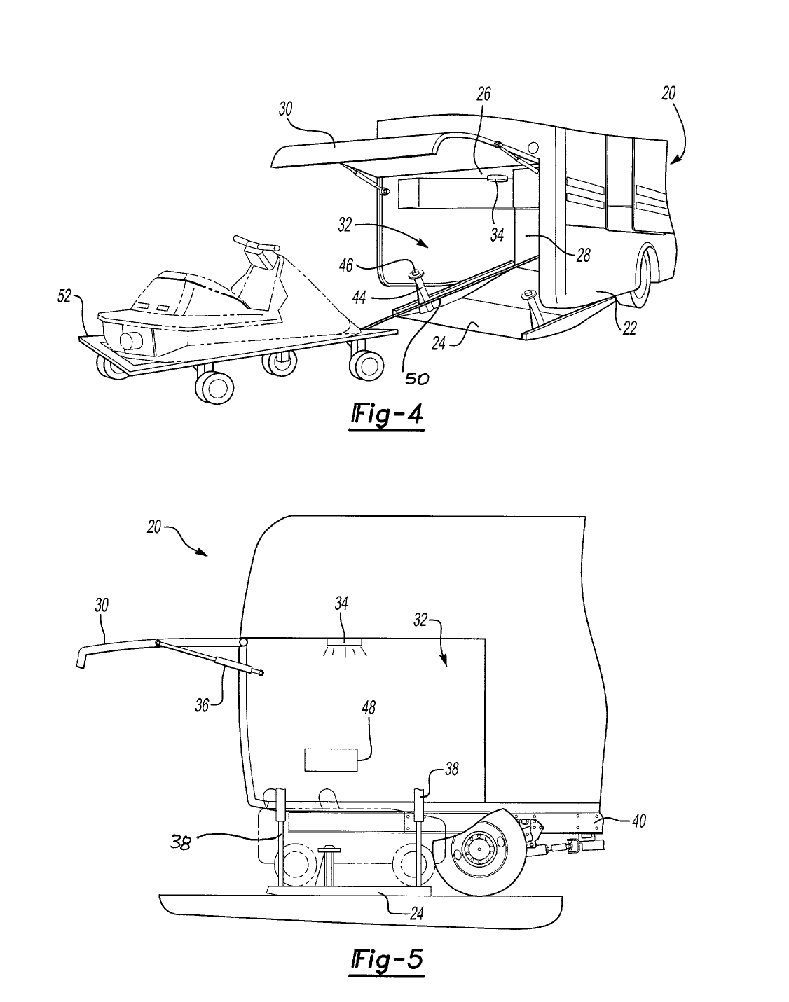

FIG. 4 illustrates a perspective view of an embodiment of the present invention including devices to assist in the loading and unloading of certain types of the auxiliary loads stored within the storage compartment 32. In this embodiment watercraft such as personal watercraft can be launched from the vehicle 20 through the use of a wheeled dolly 52 that is lowered and retrieved from the storage compartment 32 by the winch device and cable 50. The wheeled dolly 52 can be configured to assist in lowering or retrieving a variety of auxiliary loads.

An alternate embodiment of the present invention is illustrated in FIG. 5 with the drop deck 24 in a level lowered position. Here, the drop deck 24 is configured without the hinge or hinges 42. The drop deck 24 can be raised and lowered in a level position using hydraulic lift cylinders 38 that simultaneously raise and lower the drop deck 24 like an elevator. This allows the drop deck 24 to be lowered, raised and stored in a level plane. The amount of chassis 40 overhang from the wheel and vehicle 20 size would limit the drop deck 24 size. In this configuration, the storage compartment 32 could even be used as a semi-enclosed porch.

The present invention can also include a means to prevent the vehicle 20 from moving when the drop deck 24 is in a lowered position, or to prevent the drop deck 24 from lowering if the vehicle 20 has the potential to move. For example, a “kill” switch (not shown) could be used to monitor the presence of a PRNDL gear selector position and the position of the drop deck 24. If the gear selector is not in “Park,” the vehicle 20 operator could be prohibited from lowering the drop deck 24. Further, if the drop deck 24 is lowered, the operator could be prohibited from taking the gear selector out of “Park.” Indicator lamps would also be useful to let the operator know the position of the drop deck 24. These functions can use various sensor means known in the art such as a drop deck position sensor connected to an indicator means such as a lamp or a sound to alert the vehicle 20 operator of the position of the drop deck 24, or PRNDL gear selector position sensor attached to a controller or a “kill” switch.

Various alterations and changes can be made to the illustrated embodiment of the present invention without departing from the spirit and broader aspects of the invention as set forth in the appended claims, which are to be interpreted in accordance with the principles of patent law, including the doctrine of equivalence. The embodiment of the invention in which exclusive property or privileges claimed are defined as follows.

I claim:

1. A vehicle having a storage compartment to enclose an auxiliary load, comprising:
a chassis, comprising a drop deck;
a body mounted to the chassis comprising body walls in combination with the drop deck, a ceiling, and at least one hatch hingedly attached to the body to define the storage compartment;
the drop deck comprising a means to raise the drop deck to a closed and lower to an open position, and a means to secure the drop deck in the closed position.

2. The vehicle of claim 1, wherein the areas within the storage compartment are lined with a firewall rated material.

3. The vehicle of claim 1, wherein the hatch further comprises at least one gas shock with a first gas shock end attached to a hatch edge and a second gas shock end attached to the vehicle body, thereby assisting in raising the hatch and holding the hatch in an open position.

4. The vehicle of claim 1, wherein an edge of the drop deck is hingedly mounted to the chassis.

5. The vehicle of claim 1, wherein the means to raise and lower the drop deck is at least one hydraulic lift cylinder with a first cylinder end attached to the chassis and a second cylinder end attached to the an edge of the drop deck, the hydraulic lift cylinder having sufficient power to raise and lower the drop deck and the auxiliary load.

6. The vehicle of claim 5, comprising at least four hydraulic lift cylinders configured to lower, raise and store the drop deck in a level plane.

7. The vehicle of claim 1, wherein the means to secure the drop deck in the closed position comprises at least one post attached to the drop deck, the post comprising a post stop adjacent and corresponding to a releasable latching device attached to the chassis configured to receive the post stop and to support the drop deck and the auxiliary load.

8. The vehicle of claim 1, further comprising a winch device and cable attached to the storage compartment on an interior surface adjacent to the hatch.

9. The vehicle of claim 8, wherein the winch device and cable further comprises a wheeled dolly.

10. The vehicle of claim 1, wherein the body walls are reinforced, whereby injury to the vehicle or surrounding vehicles is minimized if the auxiliary load shifts during transport.

11. The vehicle of claim 1, comprising two hatches on adjacent body walls.

12. The vehicle of claim 1 further including a means to prevent the vehicle from driving off when the drop deck is in a lowered position.

13. The vehicle of claim 12, wherein the means to prevent the vehicle from driving off when the drop deck is in a lowered position comprises a drop deck position sensor connected to an indicator lamp to alert the vehicle operator of the position of the drop deck.

14. The vehicle of claim 12, wherein the means to prevent the vehicle from driving off when the drop deck is in a lowered position comprises a “kill” switch, a PRNDL gear selector position sensor, and a drop deck position sensor wherein the vehicle operator could be prohibited from lowering the deck if the PRNDL gear selector is not in “Park,” and if drop deck 24 is lowered, the operator could be prohibited from taking the PRNDL gear selector out of “Park.”

15. The vehicle of claim 1, wherein the vehicle comprises additional interior spaces.

16. The vehicle of claim 15, wherein the storage compartment is located in the rear of the vehicle, and the hatch is located on a rear wall of the vehicle.

17. The vehicle of claim 15, wherein the storage compartment is located in the front of the vehicle, and the hatch is located on a front wall of the vehicle.

18. The vehicle of claim 15, wherein the additional interior space extends over the storage compartment ceiling and further comprises an access door on a body wall or ceiling, whereby the storage compartment can be accessible to the other interior spaces of the vehicle.

19. A vehicle having a storage compartment to enclose an auxiliary load, comprising:
a chassis, comprising a fixed deck; and
a body mounted to the chassis comprising body walls in combination with the drop deck, a ceiling, and at least one hatch hingedly attached to the body to define the storage compartment.
